(19) United States
(12) Patent Application Publication
(10) Pub. No.: US 2010/0074593 A1
(43) Pub. Date: Mar. 25, 2010

(54) METHOD AND APPARATUS FOR CONTROLLING RECORDING OF IMAGE DISPLAY DEVICE

(75) Inventor: Suck-Hwa Jung, Gumi-city (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/374,967

(22) PCT Filed: Jun. 13, 2007
(86) PCT No.: PCT/KR2007/002852

§ 371 Date: Nov. 24, 2009

(30) Foreign Application Priority Data
Aug. 29, 2006 (KR) 10-2006-0082015

(51) Int. Cl. H04N 5/91; H04N 7/26

(52) U.S. Cl. 386/83; 386/109; 386/E05.003

(57) ABSTRACT

Provided are an apparatus and a method for controlling the recording of an image display device having a storage unit. When a recording instruction is input and an automatic image quality mode is selected, a noise level of the broadcast signal is measured and a compression rate or resolution of the broadcast signal to be recorded is automatically set depending on the measured noise level. Accordingly, it is possible to remove the inconvenience of manually setting the image quality condition of the broadcast signal whenever recording is performed, and to provide an optimized image quality. Further, it is also possible to enhance the efficiency of the storage space because the image quality condition is selectively set depending on a noise level of the broadcast signal to be recorded.

### TECHNICAL FIELD

The present invention relates to an image display device, and more particularly, to an apparatus and a method for controlling the recording of an image display device having a storage unit, for measuring a noise level of the broadcast signal and auto-matically setting the image quality condition depending on the measured noise level when a user desires to record the broadcast signal of a predetermined channel.

### BACKGROUND ART

A television is a typical example of an image display device. The television receives selectively a broadcast signal of a user-selected channel among the signals transmitted from the broadcasting stations, demodulates the received signal into a video and audio signals, processes the video and audio signals, and outputs the processed video and audio signals through a display and a speaker, respectively.

Additional functions have been added to the image display device so as to enhance the convenience of the user. For example, a personal video recorder (PVR) function is built in the image display device to record a television program in progress in real time on a storage medium such as a hard disk drive (HDD) in order to play back, pause and rewind the recorded program when a user wants to view the recorded program.

A feature that significantly differentiates the PVR from the related art video cassette recorder (VCR) is the PVR's ability to record programs for dozens of hours using a high capacity hard disk.

Also, the PVR can record a program in real time, and thus it allows users to view a program excluding advertisements with the functions of pause and rewind while viewing the program.

Furthermore, the PVR can record dozens of programs selected by the user for a later playback.

The PVR may encode (compress) the broadcast program data before storing them in the hard disk in order to save the disk space. The PVR may use one of the compression algorithms such as those included in the moving picture experts group (MPEG). When playing back the program, the PVR decodes (decompresses) the stored data using the appropriate decompression algorithms based on those used in the encoding.

A user may set a record image quality to one of a high and a standard image quality when recording a program.

### DISCLOSURE OF INVENTION

### Technical Problem

The related art method for setting the image quality condition has the inconvenience of manually setting the image quality condition of the broadcast signal whenever recording is performed.

Further, when the noise level of the broadcast signal is low, the high image quality recording shows nearly the same image quality as the standard image quality recording, whereas it takes up much more space of the storage medium.

Accordingly, the present invention is directed to a method and apparatus for controlling the recording of an image display device that substantially obviates one or more problems due to limitations and disadvantages of the related art.

An object of the present invention is to provide a method and apparatus for controlling the recording of an image display device, capable of automatically setting a quality of images to be recorded depending on a noise level of the broadcast signal.

Another object of the present invention is to provide a method and apparatus for controlling the recording of an image display device, capable of recording a program in standard image quality without a separate manipulation of a user.

Further another object of the present invention is to provide a method and apparatus for controlling the recording of an image display device, capable of saving disk space.

### Technical Solution

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for controlling recording of an image display device, the apparatus including: a key input unit for receiving a recording mode selected by a user; a noise level detector for detecting a noise level of an image signal to be recorded depending on the recording mode selected by the user; a controller for controlling the apparatus such that a compression rate of the image signal under recording is selectively set depending on the noise level detected by the noise level detector; and a storage medium for storing the image signal compressed in the compression rate in response to a control signal from the controller.

Preferably, the recording mode selected by the user is one of a high, a standard and an automatic image quality mode.

Preferably, the noise level detector detects the noise level of the image signal to be recorded by comparing data in a present target section with data in a previous target section, the target section being defined in a portion that does not contain a broadcast data.

More preferably, the portion that does not contain the broadcast data is one of a back porch section, a front porch section and a sync section.

Preferably, the noise level detector detects the noise level of the image signal to be recorded on the basis of input electric field strength of the image signal.

In another aspect of the present invention, there is provided a method for controlling recording of an image display device, the method including: receiving a recording instruction and determining a recording mode selected by a user; selectively detecting a noise level of an image signal to be recorded in the recording mode selected by the user; setting a compression rate of the image signal depending on the detected noise level; and storing the image signal in the set compression rate.

Preferably, the recording mode selected by the user is one of a high, a standard, and an automatic image quality mode.

More preferably, the selectively detecting of the noise level of the image signal to be recorded is performed only when the selected recording mode is the automatic image quality mode.

Further more preferably, the selectively detecting of the noise level of the image signal to be recorded is performed by comparing data in a present target section with data in a previous target section, the target section being defined in a portion that does not contain a broadcast data.

Preferably, the selectively detecting of the noise level of the image signal to be recorded is performed on a basis of input electric field strength of the image signal.

Preferably, the setting of the compression rate includes setting the compression rate inversely proportional to the detected noise level.

Preferably, the storing of the image signal in the set compression rate includes storing the image signal in a low compression rate and a high image quality when the set compression rate is low, and storing the image signal in a high compression rate and a standard image quality when the set compression rate is high.

In further another aspect of the present invention, there is provided an apparatus for controlling recording of an image display device, the apparatus including: a key input unit for receiving a recording mode selected by a user; a noise level detector for detecting a noise level of an image signal to be recorded depending on the recording mode selected by the user; a controller for controlling the apparatus such that a resolution of the image signal under recording is selectively set depending on the noise level detected by the noise level detector; and a storage medium for storing the image signal in the set resolution in response to a control signal from the controller.

Preferably, the recording mode selected by the user is one of a high, a standard and an automatic image quality mode.

Preferably, the resolution is set proportional to the noise level detected by the noise level detector in response to a control signal from the controller when the selected recording mode is the automatic image quality mode.

In still further another aspect of the present invention, there is provided a method for controlling recording of an image display device, the method including: receiving a recording instruction and determining a recording mode selected by a user; selectively detecting a noise level of an image signal to be recorded in the recording mode selected by the user; setting a resolution of the image signal depending on the detected noise level; and storing the image signal in the set resolution.

Preferably, the setting of the resolution of the image signal includes setting the resolution high when the detected noise level is high.

Preferably, the setting of the resolution of the image signal includes setting the resolution low when the detected noise level is low.

### ADVANTAGEOUS EFFECTS

An apparatus and a method for controlling the recording of an image display device according to the present invention have the following advantages.

First, a record image quality condition is set automatically depending on a noise level of the broadcast signal under recording. Accordingly, it is possible to remove the inconvenience of manually setting the image quality condition for the broadcast signal whenever recording is performed.

Second, it is possible to optimize the image quality because the record image quality condition is selectively set depending on a noise level of the broadcast signal under recording.

Third, it is possible to enhance the efficiency of the storage space because the record image quality condition is selectively set depending on a noise level of the broadcast signal under recording.

It will be apparent to those skilled in the art that various modifications and variations can be made in the present invention. Thus, it is intended that the present invention covers the modifications and variations of this invention provided they come within the scope of the appended claims and their equivalents.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram illustrating an apparatus for controlling the recording of an image display device according to the present invention;

FIG. 2 is a block diagram illustrating a storage medium of FIG. 1;

FIGS. 3 and 4 are diagrams illustrating a criterion for determining a noise level according to an embodiment of the present invention;

FIG. 5 is a flow chart illustrating a method for controlling the recording of an image display device according to a first embodiment of the present invention; and

FIG. 6 is a flow chart illustrating a method for controlling the recording of an image display device according to a second embodiment of the present invention.

### MODE FOR THE INVENTION

Reference will now be made in detail to the preferred embodiments of the present invention, examples of which are illustrated in the accompanying drawings. Wherever possible, the same reference numbers will be used throughout the drawings to refer to the same or like parts.

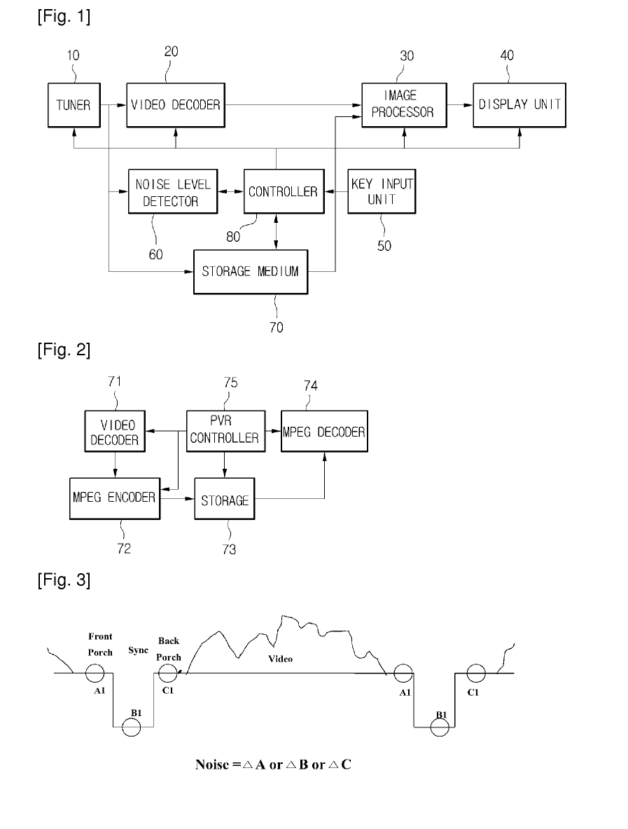

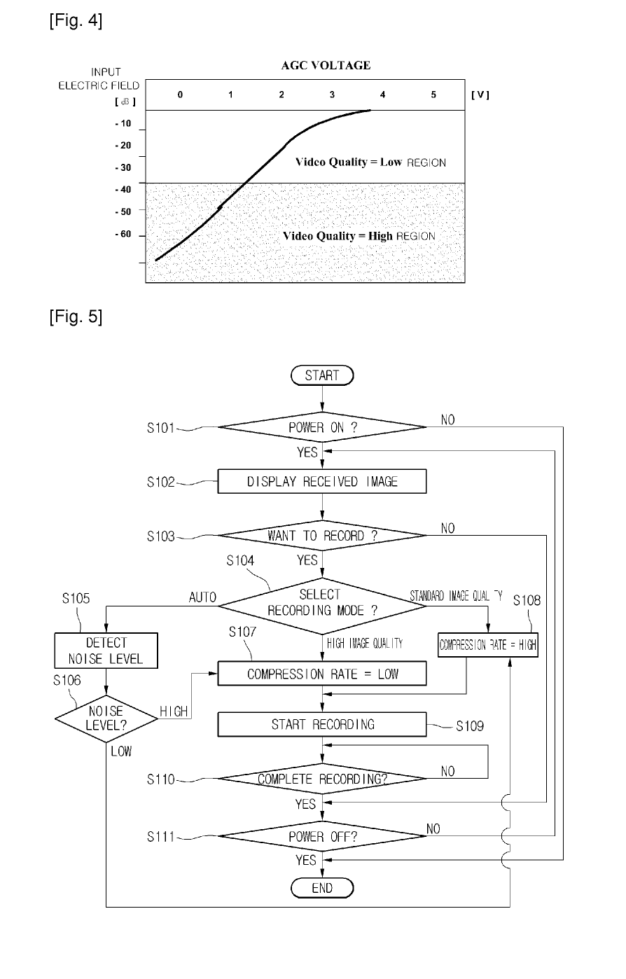

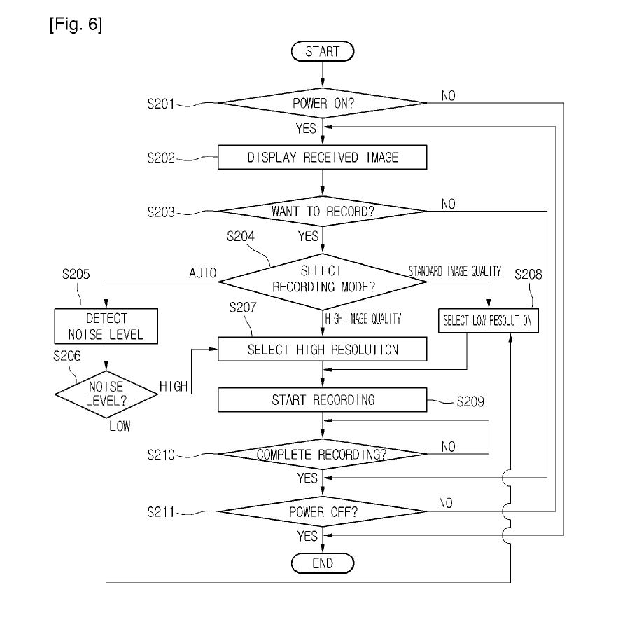

FIG. 1 is a schematic block diagram illustrating an apparatus for controlling the recording of an image display device according to the present invention. FIG. 2 is a block diagram illustrating a storage medium of FIG. 1. FIGS. 3 and 4 are diagrams illustrating a criterion for determining a noise level in an apparatus for controlling the recording of an image display device according to an embodiment of the present invention. FIG. 5 is a flow chart illustrating step by step a method for controlling the recording of an image display device according to a first embodiment of the present invention. And, FIG. 6 is a flow chart illustrating step by step a method for controlling the recording of an image display device according to a second embodiment of the present invention.

### First Embodiment

An apparatus for controlling the recording of an image display device according to the first embodiment of the present invention includes a tuner 10, a video decoder 20, an image processor 30, a display unit 40, a key input unit 50, a noise level detector 60, a storage medium 70, and a controller 80.

The tuner 10 receives selectively a broadcast signal of a user-selected channel among broadcast signals received from the outside. The video decoder 20 decodes the image signal selected by the tuner 10.

The image processor 30 processes the image signal decoded by the video decoder 20 so that it can be output in the form of a video. The display unit 40 displays an image signal processed by the image processor 30 and a menu screen for setting a record image quality condition desired by a user.

It is through the key input unit 50 that a user selects a recording mode with reference to the menu screen displayed on the display unit 40 and the user inputs instructions.

When a recording instruction is input through the key input unit 50, the noise level detector 60 detects the noise level of the image to be recorded depending on the user-selected recording mode. The controller 70 sets the compression rate of the recorded image selectively depending on the noise level detected by the noise level detector 60.

Also, the storage medium stores the image in the set compression rate in response to the control signal from the controller 80.

The storage medium 70 includes a video decoder 71, an MPEG encoder 72, a storage 73, an MPEG decoder 74, and a PVR controller 75.

The video decoder 71 converts a radio frequency (RF) signal or an audio/video (AV) signal, which is preferred in recording, to a red-green-blue (RGB) signal or a YUV signal, and then converts it further to a digital signal. The MPEG encoder 72 converts the digital signal received from the video decoder 71 to an MPEG signal.

The MPEG signal received from the MPEG encoder 72 is stored in the storage 73.

The MPEG signal stored in the storage 73 is decoded and restored to its uncompressed digital signal by the MPEG decoder 74 when a play back instruction is input by a user.

Also, the PVR controller 75 controls the recording or the playback of the user-selected broadcast signal in response to the control signal from the controller 80.

Hereinafter, the operations of the apparatus for controlling the recording of an image display device according to the first embodiment of the present invention will now be described.

To begin with, when a power on instruction is input through the key input unit 50, the controller 80 outputs a control signal to the tuner 10 so that the program of the user-selected channel may be output.

The tuner 10 selects a channel desired by a user, and the video decoder 20 receives and decodes a broadcast signal of the selected channel.

The broadcast signal thus decoded by the video decoder 20 is processed by the image processor 30 so as to be output through the display unit 40 in the form of a video.

Also, when a recording instruction is input from the key input unit 50, the controller 80 outputs a control signal so that a menu screen for setting a recording mode desired by a user may be displayed on the display unit 40.

The recording mode represents the compression rate condition of the broadcast signal that a user wants to record. The recording mode includes a high, a standard, and an automatic image quality mode.

The high image quality mode has a merit of recording the user-wanted broadcast signal in a high image quality, but also a disadvantage of taking up a relatively large space of the storage 73.

The standard image quality mode records the user-wanted broadcast signal at a higher compression rate in a standard image quality. Accordingly, the standard image quality mode has a disadvantage of poor image quality, but also a merit of taking up a small space of the storage 73 in comparison with the high image quality mode.

In addition, the automatic image quality mode sets the compression rate inversely proportional to the noise level of the user-selected broadcast signal. Accordingly, the automatic image quality mode provides an optimized image quality and enhances the efficiency of the storage space.

When the automatic image quality mode is selected by the user, the controller 80 outputs a control signal so that the noise level detector 60 detects a noise level of the user-wanted broadcast signal received from the tuner 10.

Then, the noise level detector 60 detects a noise level of the broadcast signal received through the tuner 10. According to an embodiment of the present invention, the noise level may be detected by comparing data in the present target section with data in a previous target section, the target section being defined in a portion that does not contain a broadcast data.

That is, referring to FIG. 3, the target section which does not contain a broadcast data is predefined, and data in the present target section is compared to data in the previous target section. The difference between the data in the present target section and the data in the previous target section is regarded as a noise.

Here, the target section includes a front porch section (A1), a back porch section (C1) and a sync section (B1).

Compression rates detected using the above-described method depending on the noise levels are shown in TABLE. 1.

TABLE 1

| Noise Level Detection | Compression Rate |
|---|---|
| 00~A0 | Low |
| A1~FF | High |

TABLE. 1 shows an example where uPD64015 video decoder is used with the noise detection setting of (56H)=14H.

Further, when recording an RF signal input through an antenna, a noise level may be detected relatively on the basis of input electric field strength.

Referring to FIG. 4, when the input electric field strength is low, a signal to noise ratio (S/N) is poor, and thus a noise is generated in the image. Accordingly, a noise level may be determined on the basis of input electric field strength.

The input electric field strength is generally proportional to an automatic gain control

(AGC) value of the tuner 10. Accordingly, the noise level may be determined on the basis of the AGC value of the tuner 10 in order to set the compression rate.

The controller 80 sets a compression rate of the broadcast signal depending on the noise level detected by the noise level detector 60. The compression rate of the broadcast signal is set low when the noise level is high, whereas set high when the noise level is low in order to store the broadcast signal in an optimized compression rate and enhance the efficiency of the storage space.

Hereinafter, a method for controlling the recording of an image display device according to the first embodiment of the present invention is described.

Referring to FIG. 5, to begin with, it is determined whether or not a power on instruction is input by a user (S101).

If it is determined that the power on instruction is input by the user, the image received via the antenna (not shown) is displayed (S102).

Then, it is determined whether the user wants to record the image, i.e., whether a recording instruction is input (S103).

If it is determined that the user wants to record the image, a menu screen for setting a recording mode desired by the user is displayed, and the user selects the recording mode in the displayed menu screen (S104).

When an automatic image quality mode is selected, a noise level of the user-selected broadcast signal is detected (S105).

Then, it is determined whether or not the noise level is high (S106).

If the noise level is determined to be high in S106, or a high image quality mode is selected in S104, the compression rate is set low (S107).

On the contrary, if the noise level is determined to be low in S106, or a standard image quality mode is selected in S104, the compression rate is set high (S108).

Afterwards, the broadcast signal is recorded at the compression rate set in S107 or S108 (S109).

Thereafter, it is determined whether or not the recording is completed (S110).

If the recording is completed as a result of the determination, it is determined whether or not a power off instruction is input (S111).

If it is determined that a power off instruction is input, the method ends. If not, S102 is performed.

Meanwhile, if it is determined that the user does not want to record the image in S103, S111 is performed.

### Second Embodiment

The second embodiment has technical features identical to those of the first embodiment. Accordingly, technical features different from those of the first embodiment will be described in more detail with reference to FIG. 1.

Referring to FIG. 1, an apparatus for controlling the recording of an image display device according to the second embodiment of the present invention includes a tuner 10, a video decoder 20, an image processor 30, a display unit 40, a key input unit 50, a noise level detector 60, a controller 80 for controlling the apparatus so that the resolution of the image under recording is selectively set depending on the noise level detected by the noise level detector 60, and a storage medium 70 for storing the image in the set resolution in response to the control signal from the controller 80.

The storage medium 70 includes a video decoder 71, an MPEG encoder 72, a storage 73, an MPEG decoder 74, and a PVR controller 75.

Hereinafter, the operations of the apparatus for controlling the recording of an image display device according to the second embodiment of the present invention will now be described.

To begin with, when a recording instruction is input, a menu screen for setting a recording mode desired by a user is displayed on the display unit 40 in response to a control signal from the controller 80.

The recording mode represents the resolution condition of the image that a user wants to record. The recording mode includes a high, a standard, and an automatic image quality mode.

The high image quality mode has a merit of recording the user-wanted image in a high resolution, but also a disadvantage of taking up a relatively large space of the storage 73.

The standard image quality mode sets the resolution low to record the broadcast signal in a standard image quality. Accordingly, the standard image quality mode has a disadvantage of poor image quality, but also a merit of taking up a small space of the storage 73 in comparison with the high image quality mode.

In addition, the automatic image quality mode sets the resolution proportional to the noise level of the user-wanted broadcast signal. Accordingly, the automatic image quality mode provides an optimized image quality and enhances the efficiency of the storage space.

When the automatic image quality mode is selected by the user, the controller 80 outputs a control signal so that the noise level detector 60 detects a noise level of the user-wanted broadcast signal received from the tuner 10.

Then, the noise level detector 60 detects a noise level of the broadcast signal received through the tuner 10. According to an embodiment of the present invention, the noise level may be detected by comparing data in the present target section with data in a previous target section, the target section being defined in a portion that does not contain a broadcast data.

Also, when recording an RF signal input through an antenna, a noise level may be detected relatively on the basis of input electric field strength.

The controller 80 outputs a control signal so that the resolution is set proportional to the noise level detected by the noise level detector 60.

That is, the controller 80 outputs a control signal so that the resolution of the image is set high when the noise level of the image detected by the noise level detector 60 is high, whereas set low when the noise level is low.

Then, the storage medium 70 records the image in the set resolution in response to the control signal of the controller 80.

Hereinafter, a method for controlling the recording of an image display device according to the second embodiment of the present invention is described.

To begin with, it is determined whether a power on instruction is input by a user (S201).

If it is determined that a power on instruction is input, the received image is displayed (S202).

Then, it is determined whether the user wants to record the image, i.e., whether a recording instruction is input (S203).

If it is determined that the user wants to record the image, a menu screen for setting a recording mode desired by the user is displayed, and the user selects the recording mode in the displayed menu screen (S204).

When an automatic image quality mode is selected, a noise level of the user-wanted broadcast signal is detected (S205).

Then, it is determined whether or not the noise level is high (S206).

If the noise level is determined to be high in S206, or a high image quality mode is selected in S204, the resolution of the image is set high (S207).

On the contrary, if the noise level is determined to be low in S206, or a standard image quality mode is selected in S204, the resolution of the image is set low (S208).

Afterwards, the broadcast signal is recorded in the resolution set in S207 or S208 (S209).

Thereafter, it is determined whether the recording is completed (S210).

If the recording is determined to be completed, it is determined whether a power off instruction is input (S211).

If it is determined that the power off instruction is input, the method ends. If not, S202 is performed.

Meanwhile, if it is determined that the user does not want to record the image in S203, 5211 is performed.

The features of the second embodiment that is not described above is identical to those of the first embodiment.

An apparatus and a method for controlling the recording of an image display device according to embodiments of the present invention is characterized that a compression rate or a resolution of an image under recording is selectively set depending on a noise level of the image in order to provide an optimized image quality as well as to enhance the efficiency of the storage space.

An apparatus and a method for controlling the recording of an image display device according to the present invention have the following advantages.

First, a record image quality condition is set automatically depending on a noise level of the broadcast signal under recording. Accordingly, it is possible to remove the inconvenience of manually setting the image quality condition for the broadcast signal whenever recording is performed.

Second, it is possible to optimize the image quality because the record image quality condition is selectively set depending on a noise level of the broadcast signal under recording.

Third, it is possible to enhance the efficiency of the storage space because the record image quality condition is selectively set depending on a noise level of the broadcast signal under recording.

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

The present invention has industrial applicability in that optimize the image quality because the record image quality condition is selectively set depending on a noise level of the broadcast signal under recording.

1. An apparatus for controlling recording of an image display device, the apparatus comprising:
a key input unit for receiving a recording mode selected by a user;
a noise level detector for detecting a noise level of an image signal to be recorded depending on the recording mode selected by the user;
a controller for controlling the apparatus such that a compression rate of the image signal under recording is selectively set depending on the noise level detected by the noise level detector; and
a storage medium for storing the image signal compressed in the compression rate in response to a control signal from the controller.

2. The apparatus for controlling recording of the image display device according to claim 1, wherein the recording mode selected by the user is one of a high, a standard and an automatic image quality mode.

3. The apparatus for controlling recording of the image display device according to claim 1, wherein the noise level detector detects the noise level of the image signal to be recorded by comparing data in a present target section with data in a previous target section, the target section being defined as a portion that does not contain a broadcast data.

4. The apparatus for controlling recording of the image display device according to claim 3, wherein the target section, which does not contain the broadcast data, is one of a back porch section, a front porch section and a sync section.

5. The apparatus for controlling recording of the image display device according to claim 1, wherein the noise level detector detects the noise level of the image signal to be recorded on the basis of input electric field strength of the image signal.

6. A method for controlling recording of the image display device, the method comprising:
receiving a recording instruction and determining a recording mode selected by a user;
selectively detecting a noise level of an image signal to be recorded in the recording mode selected by the user;
setting a compression rate of the image signal depending on the detected noise level; and
storing the image signal in the set compression rate.

7. The method for controlling recording of the image display device according to claim 6, wherein the recording mode selected by the user is one of a high, a standard, and an automatic image quality mode.

8. The method for controlling recording of the image display device according to claim 6, wherein the selectively detecting of the noise level of the image signal to be recorded is performed only when the selected recording mode is the automatic image quality mode.

9. The method for controlling recording of the image display device according to claim 8, wherein the selectively detecting of the noise level of the image signal to be recorded comprises detecting the noise level by comparing data in a present target section with data in a previous target section, the target section being defined as a portion that does not contain a broadcast data.

10. The method for controlling recording of the image display device according to claim 6, wherein the selectively detecting of the noise level of the image signal to be recorded comprises determining the noise level on the basis of input electric field strength of the image signal.

11. The method for controlling recording of the image display device according to claim 6, wherein the setting of the compression rate comprises setting the compression rate inversely proportional to the detected noise level.

12. The method for controlling recording of the image display device according to claim 6, wherein the storing of the image signal in the set compression rate comprises storing the image signal in a low compression rate and a high image quality when the set compression rate is low, and storing the image signal in a high compression rate and a standard image quality when the set compression rate is high.

13. An apparatus for controlling recording of an image display device, the apparatus comprising:
a key input unit for receiving a recording mode selected by a user;
a noise level detector for detecting a noise level of an image signal to be recorded depending on the recording mode selected by the user;
a controller for controlling the apparatus such that a resolution of the image signal under recording is selectively set depending on the noise level detected by the noise level detector; and
a storage medium for storing the image signal in the set resolution in response to a control signal from the controller.

14. The apparatus for controlling recording of the image display device according to claim 13, wherein the recording mode selected by the user is one of a high, a standard and an automatic image quality mode.

15. The apparatus for controlling recording of the image display device according to claim 13, wherein the resolution is set proportional to the noise level detected by the noise level detector in response to a control signal from the controller when the selected recording mode is the automatic image quality mode.

16. A method for controlling recording of an image display device, the method comprising:
receiving a recording instruction and determining a recording mode selected by a user;
selectively detecting a noise level of an image signal to be recorded in the recording mode selected by the user;
setting a resolution of the image signal depending on the detected noise level; and
storing the image signal in the set resolution.

17. The method for controlling recording of the image display device according to claim 16, wherein the setting of the resolution of the image signal comprises setting the resolution high when the detected noise level is high.

18. The method for controlling recording of the image display device according to claim 16, wherein the setting of the resolution of the image signal comprises setting the resolution low when the detected noise level is low.
